(19) United States
(12) Patent Application Publication
(10) Pub. No.: US 2008/0005675 A1
(43) Pub. Date: Jan. 3, 2008

(54) METHOD, SYSTEM AND PROGRAM PRODUCT FOR DISPLAYING NODES OF A NETWORK

(76) Inventors: GRAHAM ALDERSON, Eastleigh (GB); Stephen Loader, Lightwater (GB); Stephen Rowles, Beggarwood (GB)

Correspondence Address: IBM CORPORATION;INTELLECTUAL PROPERTY LAW, 11400 BURNET ROAD, AUSTIN, TX, 78758, US

(21) Appl. No.: 11/624,765

(22) Filed: Jan. 19, 2007

(30) Foreign Application Priority Data
Jun. 28, 2006 (GB) 0612767.4

(51) Int. Cl. G06F 15/177

(52) U.S. Cl. 715/734

(57) ABSTRACT

A method, system and program product for operating a data processing system comprises displaying on a display device a plurality of nodes of a network and a grid of intersection points, each intersection point either indicating the existence of a connection between two nodes, or indicating the lack of a connection between two nodes. Following receipt of a first user input at a user interface device, the first user input comprising selection of an intersection point, and a second user input at a user interface device, the second user input indicating a change for the selected intersection point, the change comprising an addition, deletion or amendment of a connection corresponding to the selected intersection, the display of the grid of intersection points is updated.

### BACKGROUND OF THE INVENTION

1. Technical Field

This invention relates to operating a system for displaying data in a data processing system, and in particular to a method, system and program product for operating a system for displaying a plurality of nodes of a network.

2. Description of Related Art

A network is composed, logically, of nodes and connections. Each connection joins two nodes together and each connection may be bidirectional or unidirectional. All physical and virtual networks can be represented as a set of nodes and connections. Actual physical networks such as in-home network of consumer electronics devices or a wide-spread network such as a company Intranet can be described in terms of nodes and connections. Likewise, in technical fields, for example computer programming, concepts such as state machines can be represented as a network of nodes and connections.

When dealing with a network of connected objects, such as a network of servers, it can be useful to see in one diagram how the various objects are connected together. Traditionally this is done using a graphical view; the objects are represented as nodes on a screen, with lines connecting the nodes together representing the connections between the nodes. This works very well for a small number of objects, but the diagram can rapidly become confusing and/or very large once the number of objects rises above a certain level.

In addition, traditional graphical viewing methods are difficult to make accessible as they inherently rely on graphical and mouse related manipulation. Keyboard manipulation and translation by screen readers is usually difficult and not intuitive. This is particularly relevant to users who have visual impairment or have difficulty manipulating traditional user interface devices, such as a computer mouse, with 100% accuracy. Such users rely on assistance from components such as screen readers, which will be ineffective or sub-optimal when presented with a complicated on-screen displays of nodes and connections.

It is therefore an object of the invention to improve upon the known art.

### SUMMARY OF THE INVENTION

According to a first aspect of the present invention, there is provided a method of operating a data processing system comprising displaying on a display device a plurality of nodes of a network and a grid of intersection points, each intersection point either indicating the existence of a connection between two nodes, or indicating the lack of a connection between two nodes, receiving a first user input at a user interface device, the first user input comprising selection of an intersection point, receiving a second user input at a user interface device, the second user input indicating a change for the selected intersection point, the change comprising an addition, deletion or amendment of a connection corresponding to the selected intersection point, and updating the display of the grid of intersection points.

According to a second aspect of the present invention, there is provided a data processing system comprising a display device, a processor connected to the display device and one more user input devices connected to the processor, the display device arranged to display a plurality of nodes of a network and a grid of intersection points, each intersection point either indicating the existence of a connection between two nodes, or indicating the lack of a connection between two nodes, the processor arranged, following receipt of a first user input at a user interface device, the first user input comprising selection of an intersection point, and receipt of a second user input at a user interface device, the second user input indicating a change for the selected intersection point, the change comprising an addition, deletion or amendment of a connection corresponding to the selected intersection point, to update the display of the grid of intersection points on the display device.

According to a third aspect of the present invention, there is provided a computer program product on a computer readable medium comprising instructions for operating a data processing system, the instructions for displaying on a display device a plurality of nodes of a network and a grid of intersection points, each intersection point either indicating the existence of a connection between two nodes, or indicating the lack of a connection between two nodes, for receiving a first user input at a user interface device, the first user input comprising selection of an intersection point, for receiving a second user input at a user interface device, the second user input indicating a change for the selected intersection point, the change comprising an addition, deletion or amendment of a connection corresponding to the selected intersection point, and for updating the display of the grid of intersection points.

Owing to these aspects of the invention, it is possible to provide an on-screen display of a network of nodes and connections that is easy to understand and clearly and simply shows the connections between nodes, while also showing those nodes that are not joined together. A user can, through standard user interfaces, add, delete or amend connections between nodes, by, for example, clicking on an intersection point to bring up a menu which allows a user to choose a change in the status of a connection. The data processing system provides a tabular representation of a connected network.

Advantageously, an intersection point indicating the existence of a connection between two nodes indicates the direction of the connection. The connections between nodes in the network can be displayed in a tabular or table-like format; each intersection point of the table can display a different graphic to indicate the direction of the connection. In a network which is directional, each connection has a direction which can be of three different possibilities, either travelling one way in either direction or being two-way between the two nodes. In this type of network, by using different graphics on the display device, it is possible to illustrate in a readily determinable manner, which of three possibilities actually apply to a specific connection (represented on the display device by the intersection point).

Preferably, the grid of intersection points consists of ½ (n.(n−1)) intersection points, where n is the number of nodes displayed. In a display showing the grid with this number of intersection points, then all possible connections are shown on the display device, and a user can see all of the data that they need to understand and interact with the construction of the network.

Ideally, the grid of intersection points comprises a table of n−1 rows, the first row of the table consisting of n−1 intersection points, each subsequent row of the table consisting of 1 less intersection point than the row above, where n is the number of nodes displayed. If the grid of intersection points is organised into a table of rows, then it becomes straightforward for a user to see the connections of each node, and to ascertain their status.

Advantageously, the rows of the table are left justified and the plurality of nodes are displayed at the right hand side of the table, each node adjacent a respective row of the table. By ordering the table in this way, with the node names on the right hand side, the node names are ordered and formatted in a manner that is easy to read and access and it is straightforward to identify which intersection points relate to which node.

Preferably, the method further comprises, following receipt of the first user input comprising selection of an intersection point, updating the display of the nodes to highlight the pair of nodes corresponding to the selected intersection point. The method further comprises receiving a third user input at a user interface device, the third user input comprising selection of a node, updating the display of the nodes to highlight the selected node and to highlight all nodes to which the selected node is connected, and updating the display of the grid of intersection points to highlight all intersection points which relate to the selected node.

To view more details it is possible to interact with the display and by clicking various locations, quickly and easily highlight which nodes are connected. If a node is selected in the table, the connection rows are highlighted, and any nodes to which there is a valid connection are also highlighted. If an intersection point is selected, then both of the nodes involved in the connection are highlighted (if any). When any of these highlights are active, a bottom table will display all the detailed connection information allowing the user to see the details of the number of connections, their state etc. Connections between two points can be created by right clicking in a cell to link two nodes together.

According to a fourth aspect of the present invention, there is provided a method of operating a data processing system comprising displaying on a display device a plurality of nodes of a network and a grid of intersection points, each intersection point either indicating the existence of a connection between two nodes, or indicating the lack of a connection between two nodes, wherein an intersection point indicating the existence of a connection between two nodes indicates the direction of the connection.

According to a fifth aspect of the present invention, there is provided a data processing system comprising a display device, a processor connected to the display device and one more user input devices connected to the processor, the display device arranged to display a plurality of nodes of a network and a grid of intersection points, each intersection point either indicating the existence of a connection between two nodes, or indicating the lack of a connection between two nodes, wherein an intersection point indicating the existence of a connection between two nodes indicates the direction of the connection.

According to a sixth aspect of the present invention, there is provided a computer program product on a computer readable medium comprising instructions for operating a data processing system, the instructions for displaying on a display device a plurality of nodes of a network and a grid of intersection points, each intersection point either indicating the existence of a connection between two nodes, or indicating the lack of a connection between two nodes, wherein an intersection point indicating the existence of a connection between two nodes indicates the direction of the connection.

Owing to these aspects of the invention, it is possible to present in a simple form, the nodes and connections of a directed network. In a network which is directional, each connection has a direction which is can be of three different possibilities either travelling one way in either direction or being two-way between the two nodes. In this type of network, by using different graphics on the display device, it is possible to illustrate in a readily determinable manner, which of three possibilities actually apply to a specific connection (represented on the display device by the intersection point).

### BRIEF DESCRIPTION OF THE DRAWINGS

Embodiments of the present invention will now be described, by way of example only, with reference to the accompanying drawings, in which:—

FIG. 1 is a schematic diagram of an exemplary data processing system,

FIG. 2 is a view of a screenshot of a display device showing a conventional arrangement of a network of nodes and connections,

FIG. 3 is a view of a screenshot of a display device showing an arrangement of a network of nodes and connections according to an example of the invention,

FIG. 4 is a view, similar to FIG. 3, of an exemplary screenshot of a display device of an embodiment of the invention,

FIG. 5 is a view, similar to FIG. 3, of a exemplary screenshot of a display device of an embodiment of the invention, and

FIG. 6 is a flowchart of a method of operating the data processing system of FIG. 1 with an embodiment of the invention.

### DETAILED DESCRIPTION OF A PREFERRED EMBODIMENT

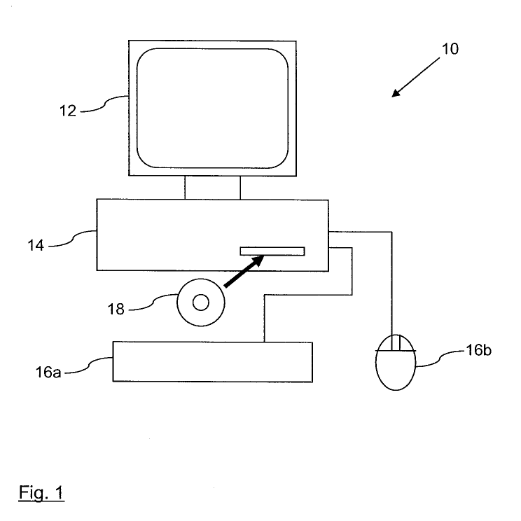

A data processing system 10 is shown in FIG. 1, which comprises a display device 12, a processor 14 connected to the display device 12 and user input devices 16 connected to the processor 14. The user input devices 16 consist of a keyboard 16a and a computer mouse 16b. A computer program product on a computer readable medium 18 is provided which includes instructions for operating the data processing system 10. The system 10, which comprises a conventional desktop computer (PC), may be connected to local and wide area networks such as the Internet. The system 10 can be used to access and display information relating to networks of nodes and connections in an embodiment of the present invention.

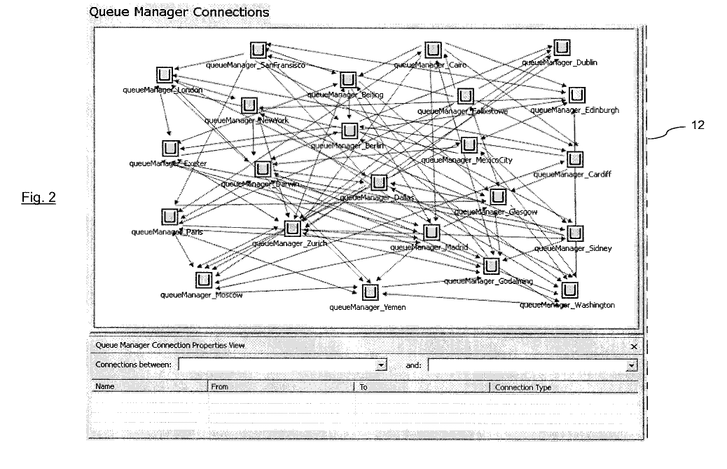

FIG. 2 shows an example of a screenshot of a connected network, as shown on a display device such as the device 12 in FIG. 1, of conventional method of displaying a connected network of nodes and connections. In this network there are 23 nodes and a large number of connections joining some of the nodes together. The connections in this network are directional, which in the representation of FIG. 2 are shown by the use of arrows for the connections, some of which arrows are double-headed indicating that the particular connection is bidirectional. There are a number of problems with the display in FIG. 2. The connections shown in the representation of the network are already starting to be confused together, and this problem will only increase as the number of nodes and connections increases. Secondly, for users with disabilities, such as partial sight, who may use a screen reader, they will have great difficulty understanding the representation, as the screen reader is unlikely to be able to correctly interpret the mass of lines on the display 12.

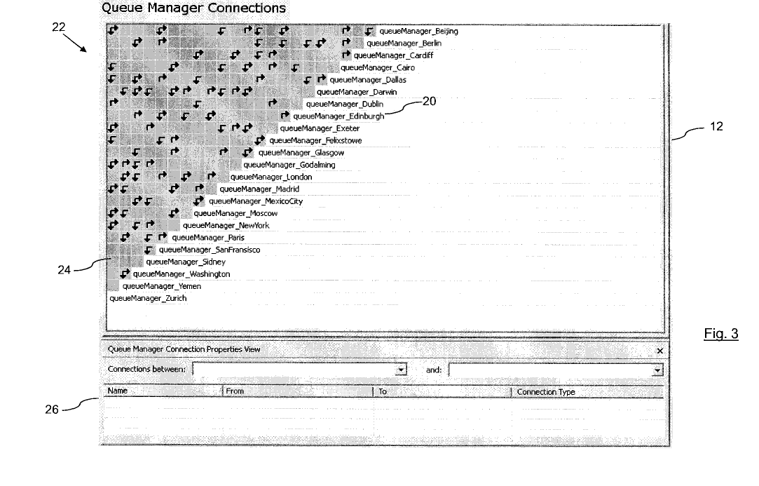

FIG. 3 shows a screenshot on a display device 12, according to an embodiment of the invention. A plurality of nodes 20 of a network and a grid 22 of intersection points 24 are arranged in a table system display for displaying the links between nodes 20, and a second standard table 26 is used underneath the grid 22 and list of nodes 20 to display the details of any connection that is currently highlighted.

The grid 22 of intersection points 24 consists of ½ (n.(n−1)) intersection points 24, formed as a table of n−1 rows, the first row of the table consisting of n−1 intersection points, each subsequent row of the table consisting of 1 less intersection point than the row above, where n is the number of nodes 20 displayed. The rows of the table are left justified and the plurality of nodes 20 are displayed at the right hand side of the table, each node 20 adjacent a respective row of the table.

This arrangement of the nodes 20 and connections is much simpler to implement than a full graphical display with connection routing, also making a visual display faster to implement. It is also much easier to make accessible (for users with, for example, partial sight) as it is based around standard text and image display in a fixed ordered environment, as opposed to the large, possibly scrolling, canvas display.

The grid 22 quickly and easily allows the user to view which of the nodes 20 are connected, and what sort of connection is in place, single direction link or a bidirectional link. Each intersection point 24 either indicates the existence of a connection between two nodes 20, or indicates the lack of a connection between two nodes 20. This allows the user to see at a glance which connections exist between which nodes 20, and also to ascertain where no connection exists. Any intersection point 24 indicating the existence of a connection between two nodes 20 also indicates the direction of the connection.

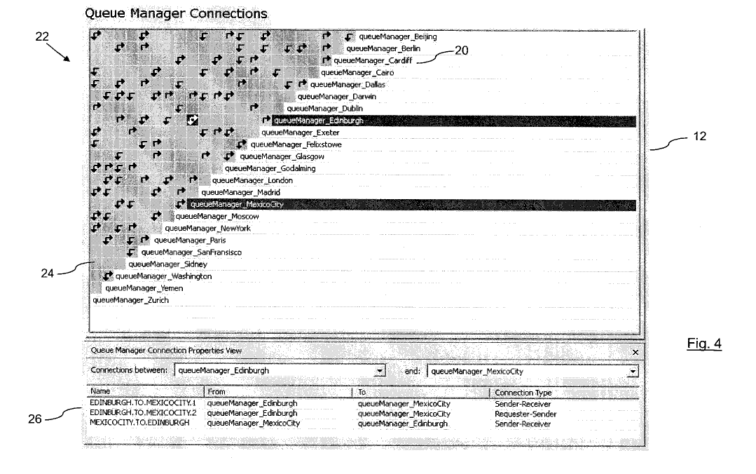

Further information about any connection can be found by a user clicking on one of the intersection point link symbols 24 in the grid 22, using the mouse 16b. In FIG. 4, the bottom table 26 now shows the details of the selected connection in place between the two nodes 20. The node view provides clear highlighting of the nodes 20 involved, and the table 26 provides all the details. When the data processing system 10 receives a user input which comprises the selection of an intersection point 24, the processor 14 updates the display of the nodes 20 on the display device 12 to highlight the pair of nodes 20 corresponding to the selected intersection point 24.

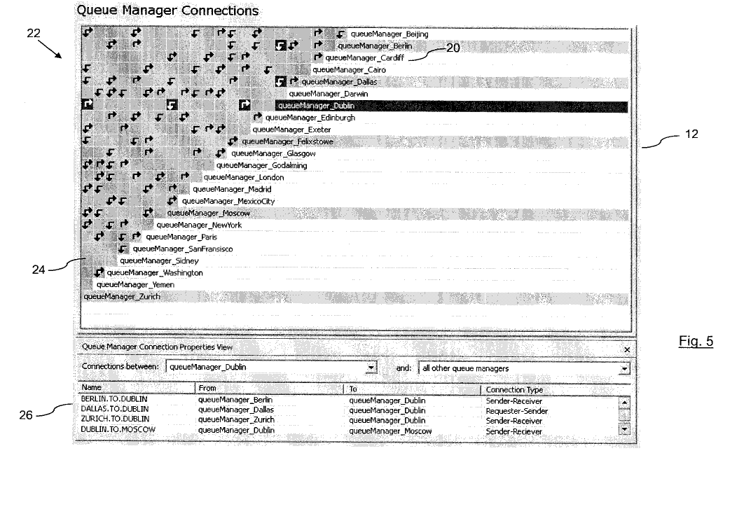

An additional style of highlighting is provided to allow the quick identification of the connected nodes 20, as shown in FIG. 5. When a user selects a node 20, this node is highlighted (in this case the node “queueManager_Dublin”) and the row in which its connections appear is highlighted, and all the additional nodes 20 to which it is connected are also highlighted. This allows simple tasks such as identifying nodes connected to a specific node X, very easy to visualise.

When the data processing system 10 receives a user input at a user interface device, which is the selection of a node 20, the processor 14 updates the display of the nodes 20 to highlight the selected node 20 and to highlight all nodes 20 to which the selected node 20 is connected, and updates the display of the grid 22 of intersection points 24 to highlight all intersection points 24 which relate to the selected node 20.

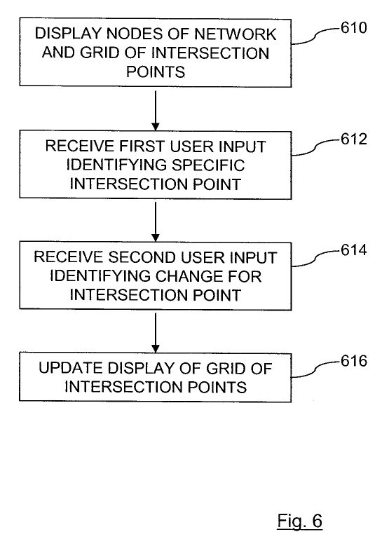

The data processing system 10 supports the altering, deletion and creation of new connections via the grid 22 of intersection points 24. FIG. 6 shows a flowchart of the actions that make up the processing of a change to the network which underlies the representation shown on the display device 12. The first step 610, as discussed in detail above, is the displaying on the display device 12 a plurality of nodes 20 of a network and a grid 22 of intersection points 24. Each intersection point 24 either indicates the existence of a connection between two nodes 20, or indicates the lack of a connection between two nodes 20.

The second step 612 is to receive a first user input at a user interface device (either the keyboard 16a or the mouse 16b). The first user input comprises the selection of an intersection point 24. The user can use the mouse 16b, for example, to click on a specific intersection point 24, to select that intersection point 24 as the one that the user wishes to change. That intersection point 24 in the grid 22 will represent a specific connection between two nodes, even if no such connection actually exists at the particular time when the user makes the selection. This is a major advantage of the representation shown in, for example, FIG. 3, which shows all possible connections, even those that do not actually exist.

The third step in the method of operating the data processing system 10 is the step 614 of receiving a second user input at the user interface device 16a or 16b, the second user input indicating the change for the selected intersection point 24. The change comprises an addition, deletion or amendment of a connection corresponding to the selected intersection point 24. The user may be selecting a specific choice from a pull down menu that appears following the selection of the specific connection, or may enter a command via the keyboard 16a. Once the change has been received by the processor 14, the final step 616 of updating the display of the grid 22 of intersection points 24 is executed.

The system 10 provides the ability to create new connections by selection an empty point 24. The ability to pick a single connection point and use this to create a new connection is a significant advantage of the system. The management of connections includes the ability to remove connections and alter their details, as well as displaying the existence of a connection. For many networks, nodes can be connected together by a large number of connections, not just the simple presence and absence of a connection. The system 10 includes the ability to alter and delete any of the many connections that are active.

Direction arrows are used in the grid 22, as opposed to just a “presence” of a connection. The display layout displays the directionality of the connections in a single point, rather just the existence of a connection. For a network where connections can be in just a single direction, this can be a major help to identify chains of point to point connections within a network. This information can be seen simply by looking at the grid 22, rather than having to select an intersection point 24 to see the details of the connection.

Another advantage of the display layout is the improved accessibility of the system 10 which aids the accessibility of a network representation over and above the normal graphical “node and line” style representation. The system 10 includes the ability to explore and visualise the network for a user with a screen reader, by providing appropriate information in each of the cells (intersection points 24).

The separate table 26 on the same display shows details relating to the selected connection or node. The display shows the information on a single page, so that the user can quickly identify the difference between connections by selecting different cells with a single click.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description but is not intended to exhaust or limit the invention in the form disclosed. Many modifications and variations will be apparent to those of ordinary skill in the art. The embodiments were chosen and described in order to best explain the principles of the invention and the practical application, and to enable others of ordinary skill in the art to understand the invention for various embodiments with various modifications as are suited to the particular use contemplated.

1. A method of operating a data processing system comprising displaying on a display device a plurality of nodes of a network and a grid of intersection points, each intersection point either indicating the existence of a connection between two nodes, or indicating the lack of a connection between two nodes, receiving a first user input at a user interface device, the first user input comprising selection of an intersection point, receiving a second user input at a user interface device, the second user input indicating a change for the selected intersection point, the change comprising an addition, deletion or amendment of a connection corresponding to the selected intersection point, and updating the display of the grid of intersection points.

2. A method according to claim 1, wherein an intersection point indicating the existence of a connection between two nodes indicates the direction of the connection.

3. A method according to claim 1, wherein the grid of intersection points consists of ½ (n.(n−1)) intersection points, where n is the number of nodes displayed.

4. A method according to claim 3, wherein the grid of intersection points comprises a table of n−1 rows, the first row of the table consisting of n−1 intersection points, each subsequent row of the table consisting of 1 less intersection point than the row above, where n is the number of nodes displayed.

5. A method according to claim 4, wherein the rows of the table are left justified and the plurality of nodes are displayed at the right hand side of the table, each node adjacent a respective row of the table.

6. A method according to claim 1, further comprising, following receipt of the first user input comprising selection of an intersection point, updating the display of the nodes to highlight the pair of nodes corresponding to the selected intersection point.

7. A method according to claim 1, and further comprising receiving a third user input at a user interface device, the third user input comprising selection of a node, updating the display of the nodes to highlight the selected node and to highlight all nodes to which the selected node is connected, and updating the display of the grid of intersection points to highlight all intersection points which relate to the selected node.

8. A data processing system comprising a display device, a processor connected to the display device and one more user input devices connected to the processor, the display device arranged to display a plurality of nodes of a network and a grid of intersection points, each intersection point either indicating the existence of a connection between two nodes, or indicating the lack of a connection between two nodes, the processor arranged, following receipt of a first user input at a user interface device, the first user input comprising selection of an intersection point, and receipt of a second user input at a user interface device, the second user input indicating a change for the selected intersection point, the change comprising an addition, deletion or amendment of a connection corresponding to the selected intersection point, to update the display of the grid of intersection points on the display device.

9. A system according to claim 8, wherein an intersection point indicating the existence of a connection between two nodes indicates the direction of the connection.

10. A system according to claim 8, wherein the grid of intersection points consists of ½ (n.(n−1)) intersection points, where n is the number of nodes displayed.

11. A system according to claim 10, wherein the grid of intersection points comprises a table of n−1 rows, the first row of the table consisting of n−1 intersection points, each subsequent row of the table consisting of 1 less intersection point than the row above, where n is the number of nodes displayed.

12. A system according to claim 11, wherein the rows of the table are left justified and the plurality of nodes are displayed at the right hand side of the table, each node adjacent a respective row of the table.

13. A system according to claim 8, wherein the processor is further arranged, following receipt of the first user input comprising selection of an intersection point, to update the display of the nodes, on the display device, to highlight the pair of nodes corresponding to the selected intersection point.

14. A system according to claim 8, wherein the processor is further arranged, following receipt of a third user input at a user interface device, the third user input comprising selection of a node, to update the display of the nodes, on the display device, to highlight the selected node and to highlight all nodes to which the selected node is connected, and to update the display of the grid of intersection points, on the display device, to highlight all intersection points which relate to the selected node.

15. A computer program product on a computer readable medium comprising instructions for operating a data processing system, the instructions displaying on a display device a plurality of nodes of a network and a grid of intersection points, each intersection point either indicating the existence of a connection between two nodes, or indicating the lack of a connection between two nodes, for receiving a first user input at a user interface device, the first user input comprising selection of an intersection point, for receiving a second user input at a user interface device, the second user input indicating a change for the selected intersection point, the change comprising an addition, deletion or amendment of a connection corresponding to the selected intersection point, and for updating the display of the grid of intersection points.

16. A computer program product according to claim 15, wherein an intersection point indicating the existence of a connection between two nodes indicates the direction of the connection.

17. A computer program product according to claim 15, wherein the grid of intersection points consists of ½ (n.(n−1)) intersection points, where n is the number of nodes displayed.

18. A computer program product according to claim 17, wherein the grid of intersection points comprises a table of n−1 rows, the first row of the table consisting of n−1 intersection points, each subsequent row of the table consisting of 1 less intersection point than the row above, where n is the number of nodes displayed.

19. A computer program product according to claim 18, wherein the rows of the table are left justified and the plurality of nodes are displayed at the right hand side of the table, each node adjacent a respective row of the table.

20. A computer program product according to claim 15, and further comprising instructions for, following receipt of the first user input comprising selection of an intersection point, updating the display of the nodes to highlight the pair of nodes corresponding to the selected intersection point.
